(19) United States
(12) Patent Application Publication
(10) Pub. No.: US 2010/0045559 A1
(43) Pub. Date: Feb. 25, 2010

(54) Dual-Band Dipole Microwave Ablation Antenna

(75) Inventor: Francesca Rossetto, Longmont, CO (US)

Correspondence Address: TYCO Healthcare Group LP;Attn: IP Legal, 5920 Longbow Drive, Mail Stop A36, Boulder, CO, 80301-3299, US

(73) Assignee: Vivant Medical, Inc.

(21) Appl. No.: 12/197,601

(22) Filed: Aug. 25, 2008

(51) Int. Cl. H01Q 9/16

(52) U.S. Cl. 343/792

(57) ABSTRACT

A microwave antenna assembly is disclosed. The microwave antenna assembly includes a feedline having an inner conductor, an outer conductor and an inner insulator disposed therebetween and a radiating portion including a dipole antenna having an operative length and an inductor. The inductor is adapted to adjust the operative length of the dipole antenna based on the frequency of the microwave energy supplied to the dipole antenna.

### BACKGROUND

1. Technical Field

The present disclosure relates generally to microwave antennas used in tissue ablation procedures. More particularly, the present disclosure is directed to dipole microwave antennas having dual-band capability.

2. Background of Related Art

Treatment of certain diseases requires destruction of malignant tissue growths (e.g., tumors). It is known that tumor cells denature at elevated temperatures that are slightly lower than temperatures injurious to surrounding healthy cells. Therefore, known treatment methods, such as hyperthermia therapy, heat tumor cells to temperatures above 41° C., while maintaining adjacent healthy cells at lower temperatures to avoid irreversible cell damage. Such methods involve applying electromagnetic radiation to heat tissue and include ablation and coagulation of tissue. In particular, microwave energy is used to coagulate and/or ablate tissue to denature or kill the cancerous cells.

Microwave energy is applied via microwave ablation antennas that penetrate tissue to reach tumors. There are several types of microwave antennas, such as monopole and dipole, in which microwave energy radiates perpendicularly from the axis of the conductor. A monopole antenna includes a single, elongated microwave conductor whereas a dipole antenna includes two conductors. In a dipole antenna, the conductors may be in a coaxial configuration including an inner conductor and an outer conductor separated by a dielectric portion. More specifically, dipole microwave antennas may have a long, thin inner conductor that extends along a longitudinal axis of the antenna and is surrounded by an outer conductor. In certain variations, a portion or portions of the outer conductor may be selectively removed to provide more effective outward radiation of energy. This type of microwave antenna construction is typically referred to as a “leaky waveguide” or “leaky coaxial” antenna.

Conventional microwave antennas operate at a single frequency allowing for creation of similarly shaped lesions (e.g., spherical, oblong, etc.). To obtain a different ablation shape, a different type of antenna is usually used.

### SUMMARY

According to one aspect of the present disclosure, a microwave antenna assembly is disclosed. The microwave antenna assembly includes a feedline having an inner conductor, an outer conductor and an inner insulator disposed therebetween. The assembly also includes a radiating portion enclosing a dipole antenna having an operative length and an inductor. The inductor is adapted to adjust the operative length of the dipole antenna based on the frequency of the microwave energy supplied to the dipole antenna.

According to another aspect of the present disclosure, a triaxial microwave antenna assembly is disclosed. The triaxial microwave antenna includes a feedline having an inner conductor, a central conductor disposed about the inner conductor and an outer conductor disposed about the central conductor. The triaxial microwave antenna also includes a radiating portion having a high frequency radiating section and a low frequency radiating section.

A method for forming a lesion is also contemplated by the present disclosure. The method includes the initial step of providing a microwave antenna assembly including a radiating portion having a dipole antenna with an operative length and an inductor. The method also includes the steps of: supplying microwave energy at a predetermined frequency to the microwave antenna assembly; and adjusting the operative length of the dipole antenna based on the frequency of the microwave energy supplied thereto to adjust at least one property of the lesion. The property of the lesion including a depth and a diameter.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a schematic diagram of a microwave ablation system according to an embodiment of the present disclosure;

FIG. 2 is a perspective, internal view of the microwave antenna assembly of FIG. 1 according to the present disclosure;

FIG. 3 is a cross-sectional side view of the microwave antenna assembly of FIG. 1 according to the present disclosure;

FIG. 4 is a schematic diagram of the microwave antenna assembly of FIG. 1 according to the present disclosure;

FIG. 5 is an isometric view of a radiating portion of the microwave antenna assembly of FIG. 1 according to the present disclosure;

FIG. 6 is a schematic diagram of one embodiment of a microwave ablation system according to an embodiment of the present disclosure; and

FIGS. 7A and 7B are cross-sectional side views of embodiments of the microwave antenna assembly of FIG. 6 according to the present disclosure.

### DETAILED DESCRIPTION

Particular embodiments of the present disclosure will be described herein below with reference to the accompanying drawings. In the following description, well-known functions or constructions are not described in detail to avoid obscuring the present disclosure in unnecessary detail.

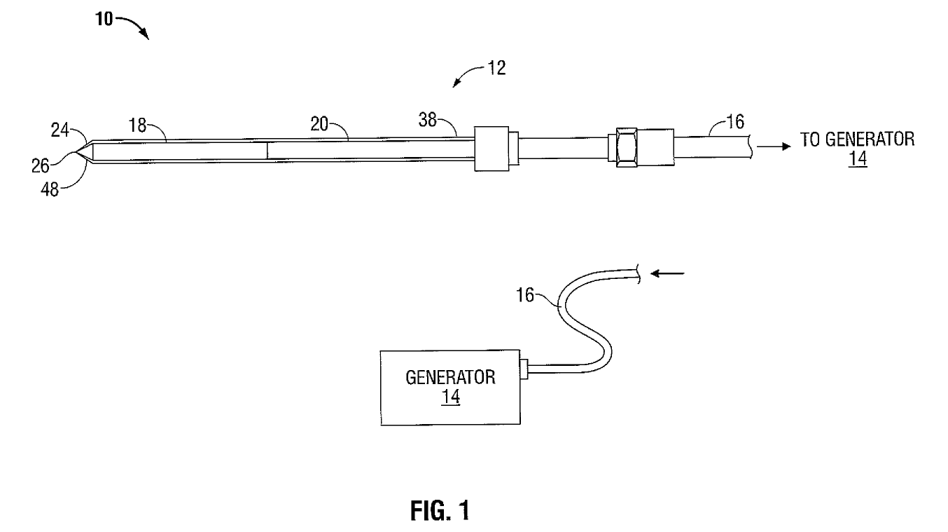

FIG. 1 shows a microwave ablation system 10 that includes a microwave antenna assembly 12 coupled to a microwave generator 14 via a flexible coaxial cable 16. The generator 14 is configured to provide microwave energy at an operational frequency from about 500 MHz to about 5000 MHz.

In the illustrated embodiment, the antenna assembly 12 includes a radiating portion 18 connected by feedline 20 (or shaft) to the cable 16. Sheath 38 encloses radiating portion 18 and feedline 20 allowing a coolant fluid to circulate around the antenna assembly 12. In another embodiment, a solid dielectric material may be disposed therein.

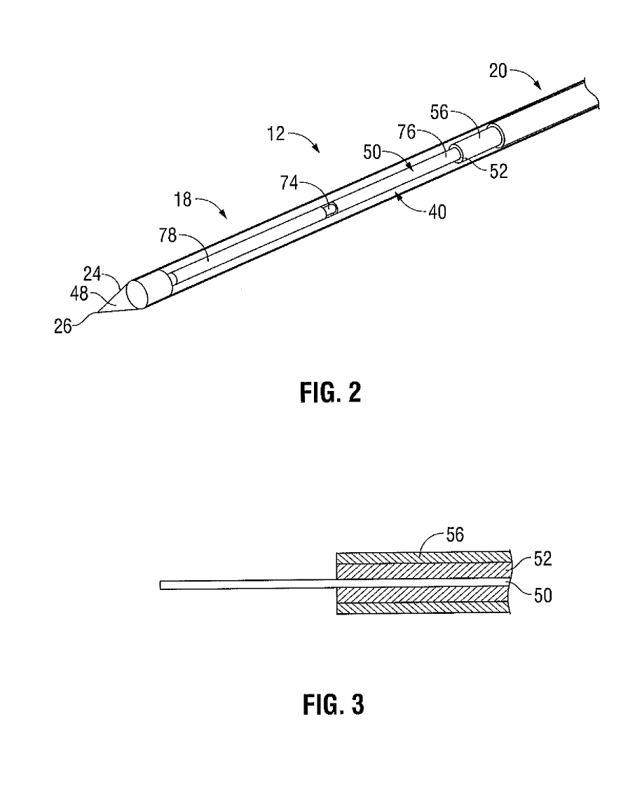

FIG. 2 illustrates the radiating portion 18 of the antenna assembly 12 having a dipole antenna 40. The dipole antenna 40 is coupled to the feedline 20 that electrically connects antenna assembly 12 to the generator 14. As shown in FIG. 3, the feedline 20 includes an inner conductor 50 (e.g., a wire) surrounded by an inner insulator 52, which is, in turn, surrounded by an outer conductor 56 (e.g., a cylindrical conducting sheath). The inner and outer conductors 50 and 56 may be constructed of copper, gold, stainless steel or other conductive metals with similar conductivity values. The metals may be plated with other materials, e.g., other conductive materials, to improve their properties, e.g., to improve conductivity or decrease energy loss, etc. In one embodiment, the feedline 20 may be formed from a coaxial semi-rigid or flexible cable having a wire with a 0.047″ outer diameter rated for 50 Ohms.

The dipole antenna 40 may be formed from the inner conductor 50 and the inner insulator 52, which are extended outside the outer conductor 56, as shown best in FIG. 2. In one embodiment, in which the feedline 20 is formed from a coaxial cable, the outer conductor 56 and the inner insulator 52 may be stripped to reveal the inner conductor 50, as shown in FIG. 3.

Assembly 12 also includes a tip 48 having a tapered end 24 that terminates, in one embodiment, at a pointed end 26 to allow for insertion into tissue with minimal resistance at a distal end of the radiating portion 18. In those cases where the radiating portion 18 is inserted into a pre-existing opening, tip 48 may be rounded or flat.

The tip 48, which may be formed from a variety of heat-resistant materials suitable for penetrating tissue, such as metals (e.g., stainless steel) and various thermoplastic materials, such as poletherimide, polyamide thermoplastic resins, an example of which is Ultem® sold by General Electric Co. of Fairfield, Conn. The tip 48 may be machined from various stock rods to obtain a desired shape. The tip 48 may be attached to the distal portion 78 using various adhesives, such as epoxy seal. If the tip 48 is metal, the tip 48 may be soldered or welded to the distal portion 78.

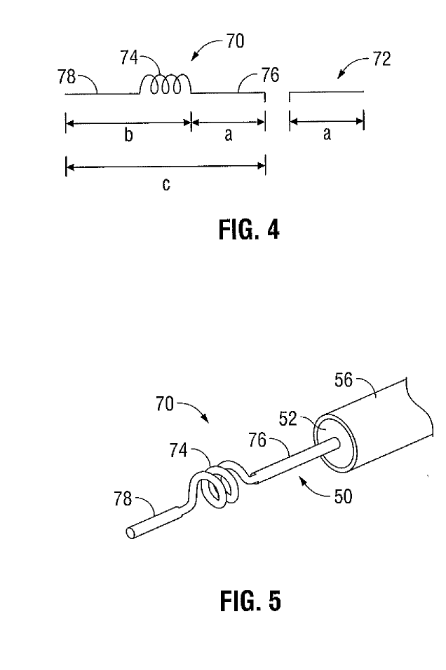

When microwave energy is applied to the dipole antenna 40, the extended portion of the inner conductor 50 acts as a first pole 70 and the outer conductor 56 acts as a second pole 72, as represented in FIG. 4. As shown in FIG. 5, the first pole 70 includes an inductor 74 that maybe disposed between a proximal portion 76 and a distal portion 78 of the first pole 70. The distal portion 78 and the proximal portion 76 may be either balanced (e.g., of equal lengths) or unbalanced (e.g., of unequal lengths).

The second pole 72 (FIG. 4) may have a first predetermined length a, that may be a quarter wavelength of the operating amplitude of the generator 14 at a first frequency. More specifically, the generator 14 may be adapted to operate at various frequencies, such as first and second frequencies, 2450 MHz and 915 MHz, respectively. Accordingly, the length a may be a quarter wavelength of the amplitude of the microwave energy supplied at 2450 MHz (e.g., λ_{eHF}/4, wherein HF is the first frequency or the high frequency). Other suitable frequencies are contemplated by the present disclosure.

The proximal portion 76 of the first pole 70 may be substantially the same length, as the second pole 72, namely length a. The distal portion 78 may have a second predetermined length b, such that the total length of the first pole 70 may be length c, which is the sum of the lengths a and b. Length c may be a quarter wavelength of the operational amplitude of the generator 14 at the second frequency, namely 915 MHz (e.g., λ_{eLF}/4, wherein LF is the second frequency or the low frequency). Those skilled in the art will appreciate that the length of the second pole 72 and the proximal portion 76 as well as the total length of the first pole 70 are not limited to a quarter wavelength of the operating frequency and can be any suitable length maintaining the proportional length relationship discussed herein.

The inductor 74, which may be a meandered strip or any suitable type of inductor, may have an impedance proportional to the frequency of the signal supplied by the generator 14, such that the impedance of the inductor 74 is relatively high when the generator 14 is operating at the first frequency (e.g., 2450 MHz) and lower when the generator 14 is outputting at the second frequency (e.g., 915 MHz).

At the first frequency, the impedance of the inductor 74 is high and, therefore, blocks the high frequency microwave signal from reaching the distal portion 78 of the first pole 70. As a result, the microwave signal energizes the second pole 72 and the proximal portion 76 of the first pole 70, hence only the second pole 72 and the proximal portion 76 resonate. In other words, first operative length (e.g., the total resonating length) of the antenna 40 is going to be the sum of second pole 72 and the proximal portion 76 and is approximately half the wavelength of the operational amplitude of the generator 14 at the first frequency (e.g., λ_{eHF}/4+λ_{eHF}/4−λ_{eHF}/2).

At the second frequency, the impedance of the inductor 74 is lower and, therefore, allows for propagation of the lower frequency microwave signal to the distal portion 78. Since the microwave signal energizes the second pole 72 and the first pole 70 in its entirety, the first and second pole 70 and 72 fully resonate. As a result, second operative length (e.g., the total resonating length) length of the antenna 40 is the sum of the second pole 72 and the first pole 70 and is approximately half the wavelength of the operational amplitude of the generator 14 at the second frequency (e.g., λ_{eLF}/4+λ_{eHF}/4).

Since the antenna 40 is resonant at the first and second frequencies, the total length of the first pole 70 and the second pole 72 may be λ_{eLF}/2, in which case the length of the first pole 70 is not equal to λ_{eLF}/4. To ensure broadband behavior at both frequencies, a choke is not used. A coolant fluid may be supplied into the sheath 38 (FIG. 1) to limit ablation of tissue along the shaft of the assembly 12.

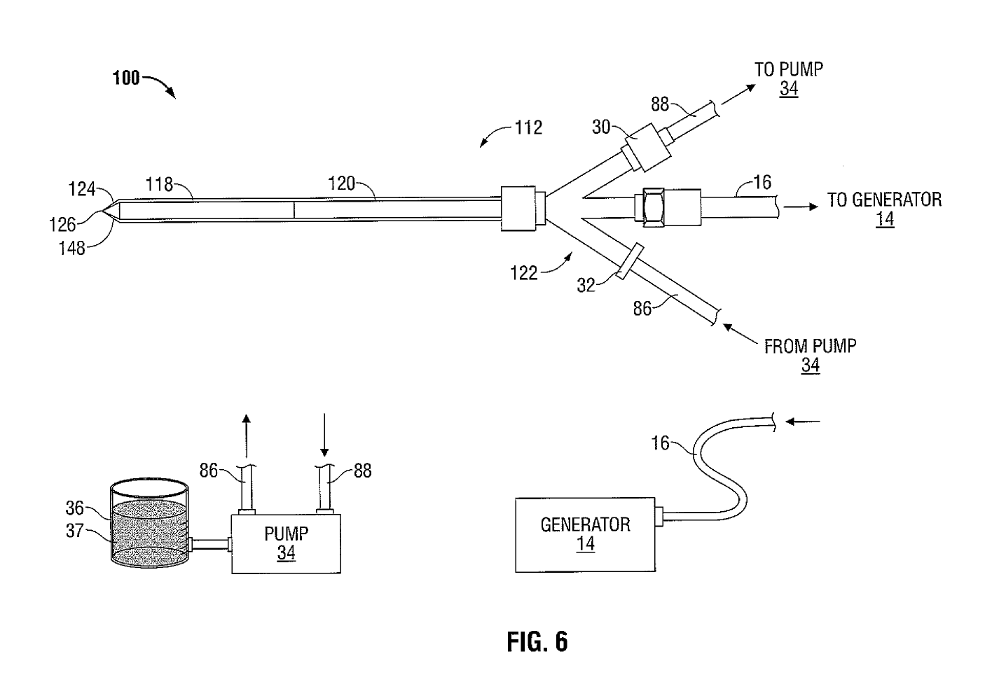

FIG. 6 shows a microwave ablation system 100 that includes a triaxial microwave antenna assembly 112 coupled to the microwave generator 14 via the flexible coaxial cable 16. The triaxial antenna assembly 112 includes a radiating portion 118 connected by feedline 120 (or shaft) to the cable 16. More specifically, the triaxial antenna assembly 112 is coupled to the cable 16 through a connection hub 22 having an outlet fluid port 30 and an inlet fluid port 32 allowing a coolant fluid 37 to circulate from ports 30 and 32 around the triaxial antenna assembly 112. The coolant fluid 37 may be a dielectric coolant fluid such as deionized water or saline. The ports 30 and 32 are also coupled to a supply pump 34 that is, in turn, coupled to a supply tank 36 via supply line 86. The supply pump 34 may be a peristaltic pump or any other suitable type. The supply tank 36 stores the coolant fluid 37 and, in one embodiment, may maintain the fluid at a predetermined temperature. More specifically, the supply tank 36 may include a coolant unit which cools the returning liquid from the triaxial antenna assembly 112. In another embodiment, the coolant fluid 37 may be a gas and/or a mixture of fluid and gas.

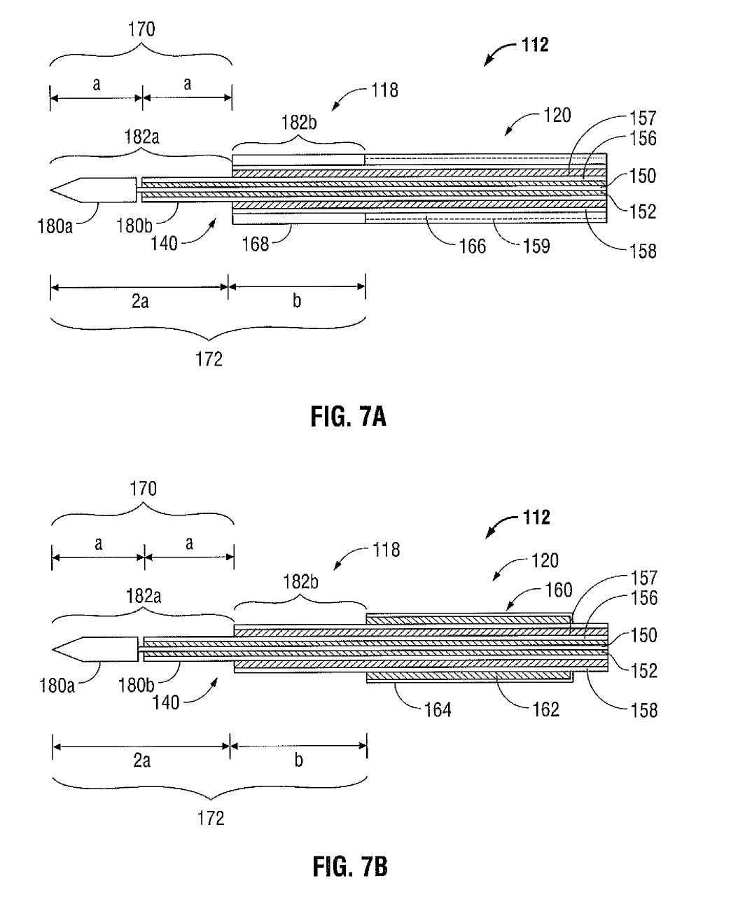

FIG. 7A illustrates the feedline 120 and the radiating portion 118 of the triaxial antenna assembly 112 having a double-dipole antenna 140. The double-dipole antenna 140 is coupled to the feedline 120 that electrically connects the triaxial antenna assembly 112 to the generator 14. The radiating portion 118 includes an inner conductor 150 (e.g., a wire) surrounded by an inner insulator 152, which is surrounded by a central conductor 156 (e.g., a cylindrical conducting sheath). The radiating portion 118 also includes a central insulator 157 disposed around the central conductor 156, which is surrounded by an outer conductor 158. The inner, central and outer conductors 150, 156 and 158, respectively, may be constructed of copper, gold, stainless steel or other conductive metals with similar conductivity values. Much like the aforementioned conductors, the metals may be plated with other materials, e.g., other conductive materials, to improve their properties, e.g., to improve conductivity or decrease energy loss, etc.

The outer conductor 158 may be surrounded by an outer jacket 159 defining a cavity 166 therebetween. In one embodiment, the outer jacket 159 may be hollow and may include the cavity 166 inside thereof. The cavity 166 is in liquid communication with the ports 30 and 32 (see FIG. 6) for circulating the coolant fluid 37 therethrough. The outer conductor 158 may also include a solid conducting portion 168 disposed at the distal end thereof. The circulation of the coolant fluid 37 through the entire length of the cavity 166 that covers the feedline 120 removes the heat generated during ablation.

The triaxial antenna assembly 112 is adapted to deliver microwave energy at two distinct frequencies (e.g., high frequency and low frequency). The inner and central conductors 150 and 156 represent the first dipole 170 of the double-dipole antenna 140, and are adapted to deliver microwave energy at a first frequency (e.g., 2450 MHz). The first dipole 170 and the outer conductor 158 represent the second dipole 172 of the double-dipole antenna 140 and are adapted to deliver microwave energy at a second frequency (e.g., 915 MHz). Thus, the central conductor 156 serves a dual purpose in the triaxial antenna assembly 112—the central conductor 156 acts as an outer conductor for the inner conductor 150 during high frequency energy delivery and as an inner conductor for the outer conductor 158 during low frequency energy delivery.

The inner conductor 150 extends outside the central conductor 156 by a first predetermined length a, which may be a quarter wavelength of the amplitude of the microwave energy supplied at 2450 MHz (e.g., λ_{eHF}/4, wherein HF is the first frequency or the high frequency). The central conductor 156 also extends outside the outer conductor 158 by the predetermined length a. During application of high frequency energy the exposed sections of the inner and central conductors 150 and 156 define a high frequency radiating section 170 having a total length equal to the sum of lengths a (e.g., λ_{eHF}/2). More specifically, during application of high frequency microwave energy, the inner conductor 150 acts as a high frequency first pole 180a and the central conductor 156 acts as a high frequency second pole 180b for the first dipole 170 of the double-dipole antenna 140.

In the embodiment illustrated in FIG. 7A, the cooling cavity 166 extends from the proximal end of the conducting portion 168 along the feedline 120, covering the outer conductor 158. During application of low frequency energy, conductors 150 and 156 along with conducting portion 168 define a low frequency radiating section 172 having a total length of 2a+b. The length b may be any length suitable such that the sum of 2a+b represents a half wavelength of the amplitude of the microwave energy supplied at the low frequency (e.g., 915 MHz). During application of low frequency energy, the inner and central conductors 150 and 156 act as a low frequency first pole 182a, and the conducting portion 168 acts as a low frequency second pole 182b for the second dipole of the double-dipole antenna 140.

With reference to FIG. 7B, the triaxial antenna assembly 112 may include a choke 160 that is disposed around the outer conductor 158. Choke 160 may include an inner dielectric layer 162 and an outer conductive layer 164. The choke 160 may be a quarter-wavelength shorted choke at the low frequency and is shorted to the outer conductor 158 at the proximal end of the choke 160 by soldering or other suitable methods. The choke 160 may replace the cooling cavity 166, and defines a portion of the radiating section 118 as a low frequency radiating section 172. More specifically, the choke 160 is disposed a second predetermined distance, length b, from the distal end of the inner conductor 150. Length b may be such that the sum of 2a+b represents half wavelength of the amplitude of the microwave energy supplied at 915 MHz (e.g., λ_{eLF}/2, wherein LF is the second frequency or the low frequency). The choke 160 is adapted to limit the bandwidth of the microwave energy only at the second frequency and does not interfere with the application of microwave energy at the first frequency.

During application of low frequency microwave energy, the inner and central conductors 150 and 156 act as a low frequency first pole 182a and a distal portion of the outer conductor 158 acts as a low frequency second pole 182b. The low frequency second pole 182b may have a length b such that in conjunction with the low frequency first pole 182a, the first and second poles 182a and 182b define a low frequency radiating section 172 having a total length equal to the sum of lengths 2a+b (e.g., λ_{eLF}/2).

The dual-frequency operation of the antenna assembly 12 and the triaxial antenna assembly 112 allows for the production of lesions of varying shape and depth. More specifically, the total operative length (e.g., the resonating portion) of the antenna 40 of the assembly 12 (FIG. 2) may be controlled by adjusting the frequency of the output of the generator 14. Since the depth of the lesion produced by the antenna 40 is directly related to the length of the resonating portion of the antenna 40, adjusting the relevant portions of the antenna 40 that resonate allows a user to control of the shape (e.g., diameter) and depth of the desired lesion. In other words, by varying the frequency of the microwave signal supplied to the antenna 40 the shape of the lesion is controlled accordingly by nature of the inductor 74 disposed on the first pole 70 (FIG. 5). The inductor 74 controls the operative length of the antenna 40 based on the frequency of the microwave energy supplied to the antenna 40.

A method for forming a lesion is also contemplated by the present disclosure. The method includes the steps of supplying microwave energy at a predetermined frequency (e.g., first or second frequency) to the microwave antenna assembly 12 and adjusting the operative length of the dipole antenna 40 based on the frequency of the microwave energy supplied thereto to adjust at least one property (e.g., depth, circumference, shape, etc.) of the lesion.

With respect to the triaxial antenna assembly 112 of FIG. 6, the depth of the desired lesion may also be varied. By applying the microwave energy at a low frequency (e.g., 915 MHz) the energy passes through the outer conductor 158 and the central conductor 156 thereby generating a lesion along the entire low frequency radiating section 172. When applying microwave at a high frequency (e.g., 2450 MHz) the energy passes through the inner and central conductors 150 and 156, thereby generating a lesion only along the high frequency radiating section 170. As shown in FIGS. 7A and 7B, energizing either or both sections 170 and 172 allows a user to generate varying depth lesions.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

What is claimed is:

1. A microwave antenna assembly, comprising:
a feedline including an inner conductor, an outer conductor and an inner insulator disposed therebetween; and
a radiating portion including a dipole antenna having an operative length and an inductor, wherein the inductor adjusts the operative length of the dipole antenna based on the frequency of the microwave energy supplied to the dipole antenna.

2. The microwave antenna assembly according to claim 1, wherein the dipole antenna includes a first pole and a second pole, the first pole including at least a portion of the inner conductor and the second pole including at a least a portion of the outer conductor.

3. The microwave antenna assembly according to claim 2, wherein the first pole includes a proximal portion having a first predetermined length and a distal portion having a second predetermined length.

4. The microwave antenna assembly according to claim 3, wherein the distal portion includes the inductor disposed on a proximal end thereof.

5. The microwave antenna assembly according to claim 4, wherein the inductor blocks the microwave energy from reaching the distal portion at a first frequency.

6. The microwave antenna assembly according to claim 5, wherein the first predetermined length is a quarter wavelength of the amplitude of the microwave energy supplied at the first frequency.

7. The microwave antenna assembly according to claim 4, wherein the inductor passes the microwave energy to the distal portion at a second frequency.

8. The microwave antenna assembly according to claim 7, wherein a sum of the first and second predetermined lengths is a quarter wavelength of the amplitude of the microwave energy supplied at the second frequency.

9. The microwave antenna according to claim 2, wherein a sum of the first and second poles is a half wavelength of the amplitude of the microwave energy supplied at the second frequency.

10. A method for forming a lesion, comprising the steps of:
providing a microwave antenna assembly including a radiating portion having a dipole antenna that includes an operative length and an inductor;
supplying microwave energy at a predetermined frequency to the microwave antenna assembly; and
adjusting the operative length of the dipole antenna based on the frequency of the microwave energy supplied thereto to adjust at least one property of the lesion.

11. The method according to claim 10, wherein the at least one property of the lesion is selected from the group consisting of shape, diameter and depth.

12. The method according to claim 10, wherein the dipole antenna of the providing step further includes a first pole and a second pole, the first pole including at least a portion of the inner conductor and the second pole including at a least a portion of the outer conductor and the inductor is disposed between the proximal portion and the distal portion.

13. The method according to claim 10, further comprising the steps of:
supplying microwave energy at a first frequency; and
blocking the microwave energy from reaching the distal portion at the inductor.

14. The method according to claim 10, further comprising the steps of:
supplying microwave energy at a second frequency; and
passing the microwave energy to the distal portion through the inductor.
